(19) United States
(12) Patent Application Publication
(10) Pub. No.: US 2010/0269765 A1
(43) Pub. Date: Oct. 28, 2010

(54) INTERCHANGEABLE DECORATIVE ANIMAL ACCESSORIES

(76) Inventor: Lisa Cozen Barghahn, Burlingame, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/428,314

(22) Filed: Apr. 22, 2009

(51) Int. Cl. A01K 27/00; A01K 25/00

(52) U.S. Cl. 119/850; 119/858

(57) ABSTRACT

Animal accessories with interchangeable exterior decorative covers. The decorative covers are removably attached to a base collar that can be continuously worn by the animal. The base collar and interchangeable exterior decorative covers can be attached to one another by any combination of magnets, hook and loop strips, snaps, buttons, clasps or similar attachment structures. Any number of different interchangeable exterior decorative covers can be created with different designs, colors or decorative aspects.

Embodiments of the invention relate to decorative animal accessories. Specifically, embodiments of the invention relate to removable and interchangeable decorative articles to be attached to a base accessory to easily change the appearance of the accessory.

### BACKGROUND

Animal collars are commonly utilized to carry tags for animals such as dogs and cats. The collars are also utilized to connect the animal to a leash. Collars are constructed from nylon, metal, cotton or leather to form a strap that is joined at one or both ends by a buckle. The buckle enables the adjustment of the size of the collar and the release of the collar. Many types of decorative aspects are incorporated into the animal collars including stitched lettering, stones, and fur. The animal collars are constructed from materials of different colors and are sized according to the animal intended to use the collar. Other types of animal accessories similar to collars include harnesses, and muzzles. These items have similar construction and can incorporate similar decorative elements.

These animal accessories all have fixed appearances. The color, style and decorative elements of each accessory are fixed. Often the owners of animals that wear the accessories seek to coordinate them with the outer wear of the owner or the animal, for example shirts, hats, or personal accessories. An owner also may desire to coordinate the appearance of the animal and its collar with activities. To change the appearance of the animal's collar or other accessory requires that the accessory be removed and another accessory with the desired appearance be put in its place. This can be a labor intensive task, because many animals are uncooperative especially when trying to place the new collar on the animal. As a result, if an owner wants to coordinate the style, color or decorative elements of an animal accessory a great deal of effort must be made. In addition, if the owner desires to coordinate over a wide variety colors, patterns, decorative elements or styles, then the owner must have animal accessories with matching colors, patterns, styles or decorative elements for each of these. Having separate matching colors for all of these purposes can incur a significant expense for the owner.

### SUMMARY

Animal accessories are coupled with interchangeable decorative covers. The decorative covers, which can be attached to a base accessory can be easily changed; yet the animal can continuously wear the same unchanged collar. The base accessory and interchangeable decorative covers can be attached to one another by any combination of hook and loop material, snaps, buttons, clasps or similar attachment structures. Any number of different interchangeable decorative covers can be utilized with any base accessory with each decorative cover having different designs, colors or decorative articles.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1A is a diagram of one embodiment of a base collar.

FIG. 1B is a diagram of another embodiment of a base collar.

FIG. 2A is a diagram of one embodiment of a removable decorative cover.

FIG. 2B is a diagram of a side view of one embodiment of a removable decorative cover.

FIG. 2C is a diagram of a bottom view of one embodiment of a removable decorative cover.

FIG. 3A is a diagram of another embodiment of a removable decorative cover.

FIG. 3B is a diagram of a side view of one embodiment of a removable decorative cover.

FIG. 3C is a diagram of a side view of one embodiment of a removable decorative cover.

FIG. 3D is a diagram a bottom view of one embodiment of a removable decorative cover.

FIG. 3E is a diagram of a cross-section of one embodiment of a removable decorative cover.

FIG. 3F is a diagram of an end view of one embodiment of a removable decorative cover.

FIG. 4A is a diagram of one embodiment of a top view of one embodiment of a combined collar and cover.

FIG. 4B is a diagram of one embodiment of a side view of one embodiment of a combined collar and cover.

FIG. 5A is a diagram of one embodiment of a collar and cover.

FIG. 5B is a diagram of one embodiment of a harness and cover.

FIG. 5C is a diagram of one embodiment of a muzzle and cover.

FIG. 6 is a flowchart of one embodiment of a process for manufacturing a combined cover and collar.

### DETAILED DESCRIPTION

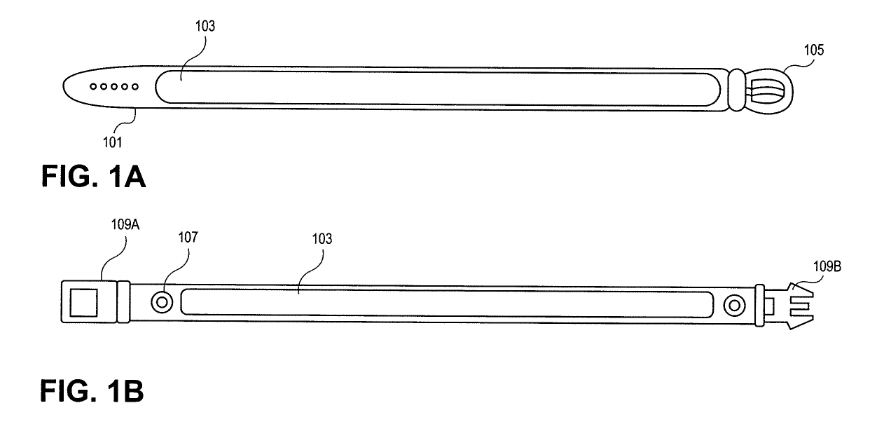

FIG. 1A is a diagram of one embodiment of a base collar. In one embodiment, the base collar is made of nylon, leather, or similar natural or artificial materials. The collar can have a length of five to thirty inches dependent on the size of the animal intended to wear the collar. The collar can have a width from half an inch to six inches. The collar can have a thickness from less than a quarter of an inch to two inches. The width and thickness can vary over the length of the collar. The size and dimensions of the collar can be determined based on the size and type of the animal that is intended to wear the collar. The collar includes a closing mechanism to attach one end to the other and form a loop. The closing mechanism can be a buckle or similar mechanism with interlocking parts on each end of the collar. A buckle can also inter-lock with holes defined by the base collar materials. In other embodiments, the closing mechanism is a clasp, snap, tie or similar closing mechanism.

In one embodiment, the base collar includes at least one closing mechanism 105, a substrate 101, and an attachment mechanism 103. The closing mechanism 105 can be a buckle, clasp, snap, tie or similar closing mechanism. The closing mechanism can be formed from stainless steel, aluminum or similar high strength materials. The closing mechanism 105 completes a loop by attaching one end of the collar to the other end of the collar. The closing mechanism 105 can have one or two parts. One part can be attached to each end of the collar. If multiple parts are utilized, then they define interlocking or complementary components.

The substrate 101 can be formed by cutting, weaving, pressing, extruding, curing or similar processes to generate a resilient material from nylon weave, leather, mesh, canvas, or similar artificial and natural materials. The substrate 101 can be a single integrated or unitary piece of material or a set of individual pieces of material that are woven, stitched, adhered, inter-locked or similarly attached to one another. The substrate 101 can be sufficient thickness and material strength to hold the weight of an animal pressing against it when attached to a leach or similar attachment. For example, the substrate 101 can have strength sufficient to hold ten to two hundred pounds of weight. The substrate 101 can also be formed to be resistant to shearing or cutting. The substrate 101 can be formed from a single material or any number of separate materials.

An attachment mechanism 103 can be attached to the substrate 101 to engage a removable and interchangeable decorative cover. The attachment mechanism 103 can be a hook or loop material such as VELCRO®, a non-slip or non-skid material, rubber material, snaps, clasps, hooks, magnets, brackets or similar mechanisms for securing or aligning the decorative cover along the length of the base collar. In another embodiment, the attachment mechanism 103 can be a set of tongue and groove components that interlock along a length of the collar and cover. The attachment mechanism 103 can be unitary or have any number of separate components. The components can be of the same type or of different types. The size of the attachment mechanism 103 can vary with the dimensions of the collar. The attachment mechanism 103 can run the length of the collar in a continuous or intermittent manner.

FIG. 1B is a diagram of another embodiment of a base collar. In this example embodiment, the collar includes interlocking clasp 109A,B. The interlocking clasp 109A,B can be formed from plastics, metals and similar resilient and high strength materials to secure the ends of the collar to one another. The interlocking clasps 109A,B can be clamped or similarly attached to the ends of the substrate of the collar. The collar includes a set of snaps 107A,B near each end of the collar to hold the ends of the decorative cover in place relative to the base collar. The snaps 107A,B can be pressed through, form fit or similarly attached to the substrate of the collar. The snaps 107A,B can be formed from stainless steel, aluminum and similar metals and alloys.

The collar includes a hook and loop strip 103 that runs the length of the collar between the snaps 107A,B to maintain the alignment and position of the decorative cover relative to the collar. The alignment of the decorative cover to the base collar ensures a masking or hiding of the base collar to achieve the desired overall decorative effect. The base collar can have any color or style, when hidden by the decorative cover only the closing mechanism is easily visible thereby attaining a matching effect between the decorative cover and other external items such as other animal accessories, clothing or similar items.

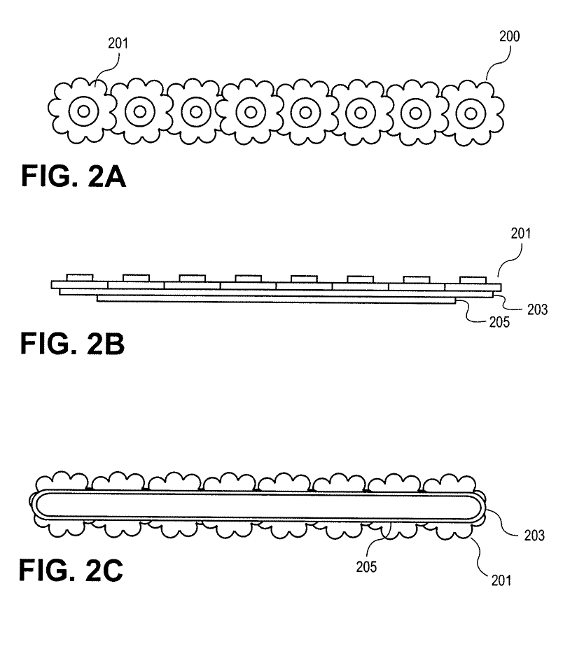

FIG. 2A is a diagram of one embodiment of a cover. The cover 200 has a set of decorative articles 201. The example cover 200 has decorative flower elements 201. Any type of decorative articles, themes or motifs can be utilized as decorative articles 201. Example decorative articles or motifs including floral, sports, hobbies, arts, cinema, professional, trade and similar motifs or themes can be utilized. The decorative materials can include plastic, cloth, sequins, rubber, ceramic, metal, or similar materials. The decorative materials can be adhered, stapled, bracketed, sewn, clamped, clasped, form fit, snapped or similarly attached to a substrate of the decorative cover. The individual decorative materials can have any shape or size. The decorative materials can have dimensions or positioning that extends beyond the substrate or base collar. Examples of decorative articles include buttons, bows, sequins, patches, ribbons or similar articles.

The substrate can have any flexible structure including mesh, weave, cloth, chain or similar material structure. The substrate can be formed from nylon, rayon, linen, rubber or other artificial or artificial materials. The substrate can be any length, width or depth. The dimensions of the substrate can be sized to be correlated to the size of the collar, such that the decorative cover substantially covers or masks the underlying collar. The coverage of the decorative collar includes the length of the collar strap or the entirety of the collar other than the buckle, clasp or similar closing mechanism.

FIG. 2B is a diagram of a side view of one embodiment of a decorative cover. The decorative articles can cover the entire substrate 203 or a portion of a substrate. The substrate 203 can form a portion of the decorative aspects of the decorative cover such as providing color, texture and similar aesthetic aspects to the decorative cover. This embodiment shows a single attachment mechanism 205 in the form of a hook and loop strip. The attachment mechanism 205 runs the entire length of the substrate 203 and has a width that roughly matches that of the substrate. The density and thickness of the hook and loop strip can be varied depending on how secure connection between decorative cover and the base collar are desired. In other embodiments, the hook and loop strip 205 can run less than the full length of the decorative cover or can be multiple shorter strips with small gaps between the strips.

FIG. 2C is a diagram of a bottom view of one embodiment of a cover. This view shows an embodiment where the attachment mechanism 205 runs the full length and width of the substrate 203. The substrate 203 and attachment mechanism 205 match a complementary attachment mechanism of the base collar. In other embodiments, the attachment mechanism is a non-slip material, magnetic material, or similar material capable of aligning the length of the decorative cover with the length of the base collar. In one embodiment, the attachment mechanism 205 is a magnetic strip or set of magnetic strips. A “set,” as used herein refers to any positive whole number of items including one item. The magnetic strip on the decorative cover can have either a north or south polarity on the exposed surface. The opposite polarity can be present on the complementary magnetic strip attached to the base collar thereby forming a breakable bond that aligns the length of the decorative cover with the length of the base collar.

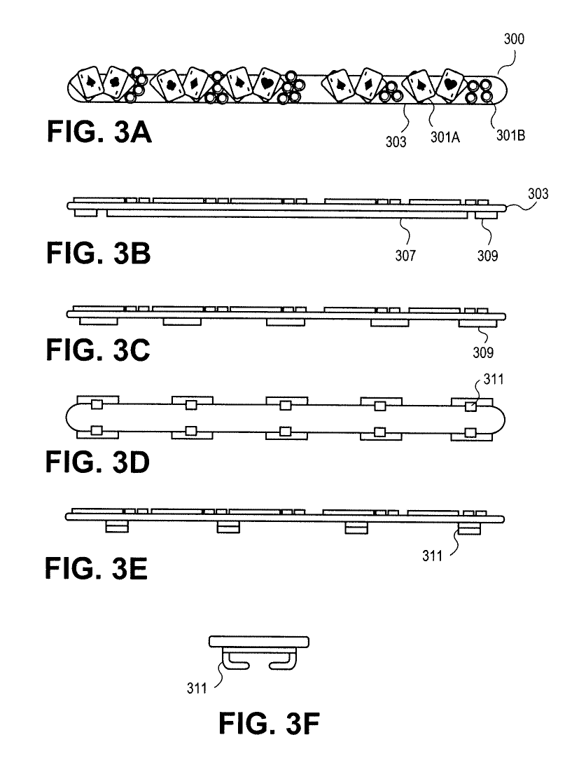

FIG. 3A is a diagram of another embodiment of a decorative cover. In this example, the cover 300 has a poker motif with plastic or resin playing cards and poker chips. Any number of decorative articles 301A,301B can be attached to a cover a substrate 303. The decorative articles 301A,301B can have any placement or arrangement on the substrate 303. The decorative articles 301A,301B can form a pattern or have any non-replicating placement. Any number of different types, sizes and shapes of decorative articles can utilized. The decorative articles can be custom manufactured for the decorative covers or any generic items of suitable size, weight and materials. The decorative articles 301A,B can be selected to have a low weight to minimize the overall weight of the collar. The decorative articles 301A,B can be attached by using adhesives, snap fit, clamping, form fit or similar mechanisms appropriate to the materials and structure of the decorative articles 301A,B. For example, the playing cards 301A and poker chips 301B can be adhered to the substrate. A felt cover or similar covering can also be placed on the substrate. Such covers or decorative articles can be layered to create a desired motif or theme.

FIG. 3B is a diagram of a side view of one embodiment of a decorative cover. The embodiment includes snaps 309 and a hook and loop strip 307. The snaps 309 are placed at or near the ends of the substrate 303 and the hook and loop strip 307 runs the length between the snaps 309. Other combinations of attachment mechanisms can include clasps, brackets, hooks and similar mechanisms. Any combination can be utilized to join the decorative cover to the base collar such that the decorative cover can replaced with another decorative cover for aesthetic purposes without having to remove the base collar from the animal.

FIG. 3C is a diagram of a side view of one embodiment of a decorative cover. This alternate embodiment utilizes a set of snaps 309 along the length of the cover. Any number of snaps 309 can be utilized including a spacing of one to three inches between snaps 309. Similar types and numbers of interlocking mechanisms can be utilized to fit the decorative covers to the base collars. Additional hook and loop strips, magnets or similar attachment mechanisms can be used between the snaps 309 to maintain an alignment of the decorative cover and the collar.

FIG. 3D is a diagram of a side view of one embodiment of a decorative cover. In this embodiment, a set of brackets 311 are attached to the substrate. The brackets 311 can be any type of brackets including fixed or moveable brackets. Moveable brackets clamp or similarly grasp the collar when attached. Any number of brackets 311 can be utilized. The brackets 311 can be spaced half an inch to six inches apart along the length of the cover. The brackets 311 can have any shape and size. The spacing, shape and size of the brackets 311 is correlated with the size and shape of the collar and cover. The brackets 311 can be a plastic, aluminum, stainless steel or similar high strength material capable of retaining its shape and securing the decorative cover to the collar.

FIG. 3E is a diagram of a cross-section of the decorative cover with brackets. The brackets 311 define an inward protruding extension that can have any width. Wider brackets improve retention, but are more difficult to separate from the base collar. FIG. 3F is a diagram of an end view of one embodiment of the cover. The end view further illustrates the shape of the brackets 311. The brackets 311 can define a channel to receive the collar by threading or inserting the collar into the channel without having to remove the collar from the animal. The brackets 311 can clamp down and change shape to further secure the cover to the collar.

FIG. 4A is a diagram of a top view of one embodiment of a combined collar and cover. The cover 401 has a sports motif with decorative articles 405 including letters and symbols 405 attached to a substrate. The combined collar 400 has a buckle 403 and set of holes 405 to adjustably receive the buckle 403. The decorative cover substantially covers the base collar such that only the closing mechanism is visible and accessible. In other embodiments, multiple separate decorative covers can be combined to cover a base collar. Any number of separate decorative covers can be combined to cover a based collar. Different themes and motifs can be constructed by varying the combination of such smaller decorative covers.

FIG. 4B is a diagram of one embodiment of a side view of one embodiment of a combined collar and cover. The side view illustrates the connection between the attachment mechanisms 409A,B and 407A,B. In the example embodiment, the attachment mechanisms 409 and 407 includes complimentary hook and loop strips 409A,B and snaps 407A,B. The attachment mechanisms 409 and 407 secures the decorative cover to the collar, while also aligning the collar and decorative cover to mask substantially the entire collar. The attachment mechanisms 409 and 407 can be symmetrically placed and sized along the length of the collar and decorative cover. In another embodiment, the attachment mechanisms have an asymmetrical placement and size to accommodate for differing areas of stress, weight or shape in the combined collar and decorative cover. The variance of size, shape and placement of the attachment mechanisms can also be utilize to facilitate the removal and replacement of the decorative covers. For example, larger and easier to release snaps can be used at one end to enable easier replacement, while the smaller or stronger snaps are used to ensure that the decorative cover is not accidentally detached and lost.

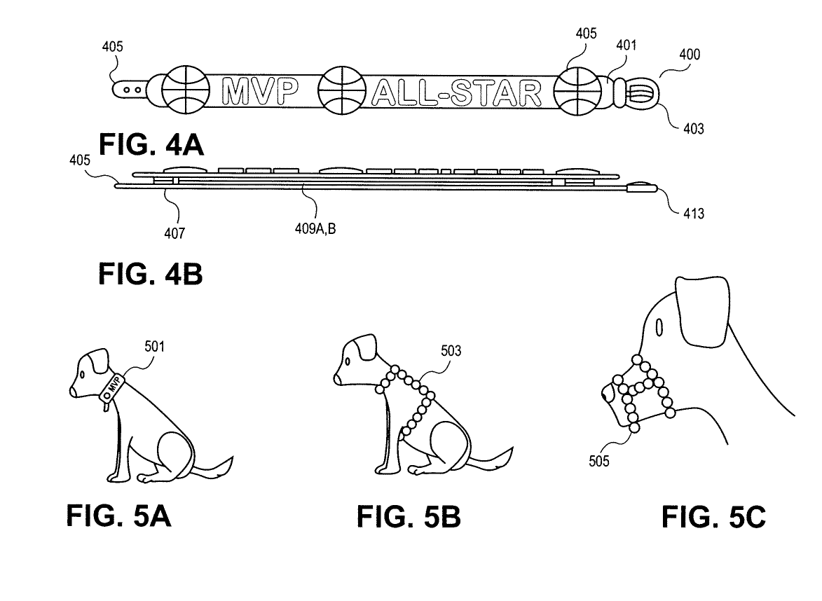

FIG. 5A is a diagram of one embodiment of a collar and cover. In the example embodiment, the combined collar and cover are sized to fit the neck of a dog, cat or similar animal. Various sizes can be manufactured to accommodate the different sizes of different breeds of dogs and cats. Collars can be adjustable within a range to accommodate small variations in size. In one embodiment, the collar may be constructed of an elastomeric or expandable material. The collar can be matched with any number of different covers to change the style, motif or theme of the collar without having to remove the collar from the animal.

FIG. 5B is a diagram of one embodiment of a harness and cover. The principles and structures of the decorative cover discussed herein in relation to collars can be adapted to other forms of animal accessories including a harness 503. The cover 503 can be a single structure that matches the structure of the harness. In another embodiment, the cover 503 can be structured in separate sections that individually attach to a base harness. The separate sections of the cover can be mixed and interchangeably attached to the harness to form different designs, styles or motifs. The sections of the cover can have any size, length, width or depth dependent on the size of the harness and the animal.

FIG. 5C is a diagram of one embodiment of a muzzle and cover. The principles and structures of the decorative cover discussed herein in relation to collars can also be applied to a muzzle 505 or similar animal accessory. The cover 505 can be a single structure that matches the structure of the muzzle 505. In another embodiment, the cover 505 can be structured in separate sections that individually attach to a base muzzle 505. The separate sections of the cover can be mixed and interchangeably attached to the muzzle to form different designs, styles or motifs. The sections of the cover can have any size, length, width or depth dependent on the size of the muzzle and the animal.

The examples of animal accessories that are provided are not intended to be exhaustive. One skilled in the art would understand that the principles and structures described herein would also be applicable to other animal accessories including leashes, belts, anklets, bands and similar accessories. For example, a cover or set of decorative covers could be placed over both the top and bottom surfaces of a leash.

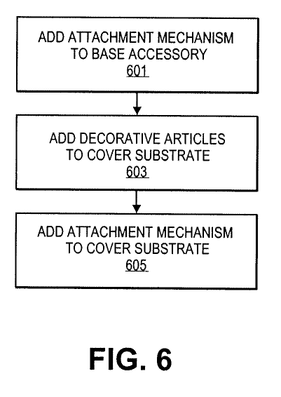

FIG. 6 is a flowchart of one embodiment of a process for manufacturing a combined cover and collar. In one embodiment, the process is initiated by the creation of a base accessory such as a harness, muzzle or collar. The base accessory can be formed by weaving, stitching, pressing, curing, cutting or similar process dependent on the type of material, accessory and size. A set of attachment mechanisms is then attached to the base accessory (block 601). The attachment mechanisms can be attached by adhering, stitching, inter-weaving, or similar techniques. The method of attaching the attachment mechanism can be selected dependent on the type of attachment mechanism and the type of the base accessory substrate materials. In one embodiment, several types or components of an attachment mechanism can be utilized including snaps, hook and loop material, clasps, brackets or similar attachment mechanisms can be utilized.

The decorative cover can be assembled separately from the base accessory (block 603). The decorative cover assembly begins with the selection or creation of a substrate. The substrate can be cut, extruded, woven or similarly manufactured dependent on the materials utilized for the substrate. The decorative articles can be attached by inter-weaving, form fit, snap fit, clamping, adhering or similar attachment method. The decorative articles can be attached by a method appropriate for the materials. The materials of the decorative articles can be from any source or of any type. Any number of individual decorative articles can added to the substrate using any combination of attachment techniques.

In one embodiment, an attachment mechanism is then attached to the other side of the substrate (block 605). Typically, the decorative articles are placed on one side of the substrate an attachment mechanism is placed on the other side of the substrate. The attachment mechanism is complementary to the attachment mechanism of the base accessory. The attachment mechanism can include magnets, snaps, buttons, clasps, hook and loop material, and similar attachment mechanisms. Any number of individual covers can be manufactured using this process. Each decorative cover can be manufactured to be interchangeable with each other and any number can be manufactured to be attached to a base accessory and thereby create an interchangeable wardrobe for the animal that can be utilized without having to change the base accessory.

In the foregoing specification, the embodiments of the invention have been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. For example, the embodiments described herein have been drawn to a compact handgun shaped marker. However, one skilled in the art would understand that the structures and principles of the interchangeable decorative cover described herein can also be applied and utilized to other types of animal accessories.

What is claimed is:

1. An article comprising:
a base collar having a first snap at a first end and a second snap at a second end and a hook and loop strip running from the first snap to the second snap; and
a cover having a first side with at least one decorative article attached and a second side with a first snap at a first end and a second snap at a second end and a hook and loop strip running from the first snap to the second snap.

2. The article of claim 1, wherein the base collar is nylon or leather.

3. The article of claim 3, wherein the cover has a substrate between the decorative article and the first snap, second snap and the hook and loop strip.

4. The article of claim 1, wherein the decorative article is woven, adhered, or interlocked with the substrate.

5. The article of claim 4, wherein the cover and base collar are removably coupled.

6. The article of claim 5, the base collar having any one of a buckle, clasp or snap.

7. The article of claim 6, wherein the cover masks substantially all of the base collar when coupled to the base collar.

8. An article comprising:
a cover for an animal accessory, the cover having a first side with a decorative article attached and a second side with an attachment mechanism for removably and interchangeably coupling the cover to an outer surface of the animal accessory the cover to mask substantially the entirety of the animal accessory.

9. The article of claim 8, wherein the attachment mechanism includes a snap, a clasp, a hook and loop strip, magnet or a bracket.

10. The article of claim 9, wherein the cover has a substrate between the decorative article and the attachment mechanism.

11. The article of claim 10, wherein the decorative article is woven, adhered, or interlocked with the substrate.

12. The article of claim 11, wherein the cover has a length of four to thirty inches.

13. The article of claim 12, wherein the substrate is nylon or leather.

14. The article of claim 13, wherein the decorative articles are made of plastic, resin or metal.

15. The article of claim 14, wherein the animal accessory is a harness

16. The article of claim 14, wherein the animal accessory is a collar.

17. The article of claim 14, wherein the animal accessory is a muzzle.
